(19) United States
(12) Patent Application Publication
(10) Pub. No.: US 2012/0284797 A1
(43) Pub. Date: Nov. 8, 2012

(54) DRM SERVICE PROVIDING METHOD, APPARATUS AND DRM SERVICE RECEIVING METHOD IN USER TERMINAL

(75) Inventors: Sergey Nikolayevich SELEZNEV, Suwon-si (KR); Byung-Rae Lee, Seoul (KR); Bo-Gyeong Kang, Seoul (KR)

(73) Assignee: Samsung Electronics Co., Ltd., Suwon-si (KR)

(21) Appl. No.: 13/461,416

(22) Filed: May 1, 2012

(30) Foreign Application Priority Data
May 3, 2011 (KR) 10-2011-0042172

(51) Int. Cl. G06F 21/00

(52) U.S. Cl. 726/26

(57) ABSTRACT

Disclosed is a DRM Proxy Server Agent (DRM PSA), which converts a format of a DRM system into a format recognizable in a user terminal when the user terminal and a service provider do not use the same type of DRM system. The user terminal downloads the DRM PSA from the service provider and installs the DRM PSA in the user terminal. Through the download and installation of the DRM PSA, the user terminal can use various DRM systems provided by the service provider regardless of the type of DRM system installed in the user terminal.

### PRIORITY

This application claims priority under 35 U.S.C. §119(a) to a Korean Patent Application entitled “DRM Service Providing Method in Service Providing Apparatus, Service Providing Apparatus for the same, and DRM Service Receiving Method in User terminal” filed in the Korean Industrial Property Office on May 3, 2011 and assigned Serial No. 10-2011-0042172, the contents of which are incorporated herein by reference.

### BACKGROUND OF THE INVENTION

1. Field of the Invention

The present invention relates generally to Digital Rights Management (DRM), and more particularly to an apparatus and a method for supporting multi-DRM for inter-compatibility between a server and a user terminal.

2. Description of the Related Art

Since the evolution of the Digital Age, the manner of distributing digital contents to a user terminal, such as a television, a computer, and a portable device, has become increasingly important.

DRM is technology for continuously managing and protecting intellectual property rights of digital contents by using encryption technology. That is, the DRM technology aims to safely deliver various contents to a user from a Content Provider (CP) and preventing the user who received the contents from illegally distributing the contents. DRM technology can protect information over an entire process from the generation, distribution, use, and discard of the digital contents, and allow the user to use the digital contents according to an authority of the user and protect the rights of the digital contents offline, as well as online.

In order to use contents to which DRM technology is applied (hereinafter DRM contents) in a user terminal, a DRM function should be installed in the user terminal.

Various schemes of DRM technology currently exist, and a service system providing digital contents supports various schemes of DRM technologies. However, the user terminal is generally released with installation of one scheme of DRM function or the user terminal is provided to the user without installation of a DRM function.

As described above, various types of DRM and Conditional Access (CA) systems currently exist. When a Terminal Vendor (TV) uses a DRM system which is different from a DRM system provided by a service provider, an issue of inter-compatibility is generated.

Further, even if the various schemes of DRM systems can be provided, the user terminal generally employs only one DRM system scheme. Thus, the user may be unable to purchase a desired type of terminal or may have difficulty in accessing a service provider.

Accordingly, there is a need in the art for a method for receiving an inter-compatible DRM system from a server supporting a plurality of DRM systems regardless of the type of DRM system supported in a user terminal.

### SUMMARY OF THE INVENTION

Accordingly, the present invention has been made to solve the above-stated problems occurring in the prior art, and the present invention provides an apparatus and a method for supporting multi DRM for inter-compatibility between a server and a user terminal.

Also, the present invention provides an apparatus and a method for receiving an inter-compatible DRM system regardless of the type of DRM system supported in a user terminal.

In accordance with the present invention, there is provided a method of providing DRM service in a service providing apparatus for inter-compatibility between the service providing apparatus and a user terminal which employ different DRM systems, the method including acquiring information of a first DRM system installed in the user terminal, determining whether the first DRM system installed in the user terminal is identical to a DRM system supported by the service providing apparatus based on the information of the first DRM system, searching, when the service providing apparatus supports a second DRM system different from the first DRM system, for a software package including a common DRM interface, which is independent of a specific DRM system, and a module for providing a function of converting the common DRM interface into the first DRM system, and providing the user terminal with the software package in such a manner that the module is installed in the user terminal.

In accordance with the present invention, there is provided a service providing apparatus for providing DRM service for inter-compatibility between the service providing apparatus and a user terminal which employ different DRM systems, the apparatus including a server for receiving information of a first DRM system installed in the user terminal, a database for storing at least one DRM server application for generating a license dependently on a DRM system supported in the service providing apparatus and at least one DRM proxy server agent software, and a DRM system coordinator for determining whether the first DRM system installed in the user terminal is identical to a DRM system supported by the service providing apparatus based on the information of the first DRM system transferred from the server, when the service providing apparatus supports a second DRM system that is different from the first DRM system, searching for a DRM proxy server agent software package for supporting a common DRM interface in the database, and providing the user terminal with the DRM proxy server agent software package such that the DRM proxy server agent is installed in the user terminal.

In accordance with the present invention, there is provided a method of receiving DRM service in a user terminal for inter-compatibility between a service providing apparatus and the user terminal which employ different DRM systems, the method including collecting information of a first DRM system installed in the user terminal, transmitting collected information of the first DRM system to the service providing apparatus, and when the service providing apparatus supports a second DRM system that is different from the first DRM system, receiving a software package including a module, which provides the DRM service in accordance with a protocol of a common DRM interface, from the service providing apparatus.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a service providing apparatus and a user terminal according to the present invention;

FIG. 2 illustrates a process of installing a DRM PSA according to the present invention;

FIG. 3 illustrates a DRM Proxy Server Agent Software (PSA S/W) package according to the present invention;

FIG. 4 illustrates an operation of a DRM system coordinator according to the present invention;

FIG. 5 illustrates an authorization process in a DRM PSA according to the present invention;

FIG. 6 illustrates a process of notifying of a result of an authorization in a DRM system coordinator according to the present invention;

FIG. 7 illustrates a process of installing a DRM server application according to the present invention; and

FIG. 8 illustrates a process of upgrading a DRM PSA according to the present invention.

### DETAILED DESCRIPTION OF EMBODIMENTS OF THE INVENTION

Hereinafter, embodiments of the present invention will be described with reference to the accompanying drawings. Various specific definitions found in the following description are provided to assist in the general understanding of the present invention, and it is apparent to those skilled in the art that the present invention can be implemented without such definitions. A detailed description of known functions and configurations incorporated herein will be omitted for the sake of clarity and conciseness.

The present invention allows a user terminal to use DRM contents acquired from a service provider in a service system providing DRM contents to which DRM technology is applied, even when a service provider and the user terminal support different DRM systems.

To this end, the present invention discloses a DRM Proxy Server Agent (DRM PSA) for converting a DRM system format into a format recognizable in the user terminal when the user terminal and the service provider do not use the same DRM system. The user terminal may download and install the DRM PSA from the service provider, through which process the user terminal can use various DRM systems provided by the service provider regardless of the DRM system type installed in the user terminal.

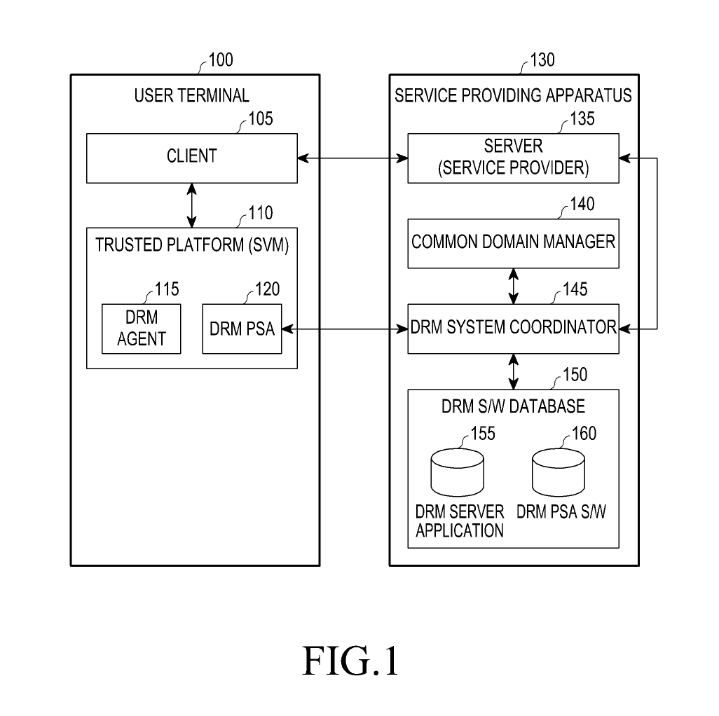

FIG. 1 illustrates an example of the user terminal and a service providing apparatus, which corresponds to the service provider. The user terminal 100 is capable of requesting, receiving, and reproducing DRM contents. An example of the user terminal 100 may include a television, a mobile phone, a Portable Multimedia Player (PMP), and a music file player. The service providing apparatus 130 is provides the user terminal 100 subscribing the multimedia service with various digital contents and managing information of users subscribing to the multimedia service. An example of the service providing apparatus 130 includes a device for providing Internet Protocol Television (IPTV) service.

Referring to FIG. 1, the user terminal 100 includes a client 105 and a trusted platform, such as a Security & Vulnerability Management (SVM) 110. The client 105 is an IPTV client, which receives, reproduces, and manages IPTV-related service.

A DRM agent 115 exists in the trusted platform 110, and the DRM PSA 120, which is downloaded from the service providing apparatus 130 and installed, exists in the trusted platform 110.

The trusted platform 110 is implemented with hardware or software within the user terminal 100 and serves to ensure a safe operation of the DRM PSA 120 and/or the DRM agent.

The DRM agent 115 and the DRM PSA 120 may be operated in the same trusted platform 110. Specifically, the DRM agent 115 is for performing an operation so as to apply the DRM in executing DRM contents. Therefore, the DRM agent 115 performs operations related to a request for multimedia service, the acquisition of a license required for execution of the requested multimedia service, and the application of the acquired license, controls a related operation of each element of the user terminal 100, and processes and generates related messages.

The DRM agent 115 is implemented as a client in accordance with a standard of any system among DRM systems employing various schemes. For example, the DRM agent 115 may be a DRM client in accordance with a standard of any DRM system among an Open Mobile Alliance (OMA) DRM system, a Marlin DRM system, and a Widevine® DRM system.

The DRM PSA 120 provides a Common DRM Interface (CDI) between the service providing apparatus 130 and the user terminal 100. When a user makes a request for the registration of the user terminal 100 to the service providing apparatus 130, the DRM PSA 120 may be downloaded and installed in the user terminal 100. Further, the DRM PSA 120 is defined between the service providing apparatus 130 and the user terminal 100 in order to provide license information required for execution of the DRM contents in a format recognizable in the user terminal 100 when the service providing apparatus 130 and the user terminal 100 do not use the same type of DRM system. Therefore, the DRM PSA 120 may provide the DRM service according to the CDI.

The DRM PSA 120 converts information transferred through the CDI into a specific format supported by the DRM agent 115 and then transfers the information to the client 105. To the contrary, the DRM PSA 120 converts a format of a message received for the purpose of the transference from the DRM agent 115 to the service providing apparatus 130 or information contained in the received message into the format of the CDI and transmits the message or the information to the service providing apparatus 130.

The DRM PSA 120 and the DRM agent 115 are communicated in accordance with a protocol under the standard of the DRM system related to the DRM agent 115. For example, when the DRM agent 115 supports the OMA DRM system and the service providing apparatus 130 supports the Marlin DRM system, the DRM PSA 120 converts the message according to the CDI from the service providing apparatus 130 into a format of the OMA DRM system.

The DRM PSA 120 may be different according to the type of DRM system provided in the DRM agent 115. That is, the DRM PSA 120 corresponding to a DRM System provided in the DRM agent 115 may be installed in the user terminal 100. In this case, a type for discriminating the DRM PSA 120 installed in the user terminal 100 may be defined. An example of the type for discriminating the DRM PSA 120 may include an OMA type for the OMA DRM system, and a marline type for the Marlin DRM system.

The service providing apparatus 130 includes a server 135, a Common Domain Manager (CDM) 140, a DRM system coordinator 145, and a DRM S/W database 150. The DRM S/W database 150 stores at least one DRM server application 155 and DRM PSA S/W 160. The DRM server application 155, which is DRM server S/W, performs a role corresponding to the DRM PSA and generates a license based on the specific DRM system. The DRM server application 155 may be different depending on a relevant DRM system or a version of the DRM system.

The server 135, which is a logical element existing within the service providing apparatus 130, corresponds to a service provider providing the client 105 with, for example, the IPTV service. The server 135 controls such functions as a process of operations related to management of a user's account, registration of a user terminal, and provision of service. The server 135 receives the DRM system type installed in the user terminal 100 from the user terminal 100 and stores the DRM system type. Further, when the server 135 provides the user terminal 100 with the service, the server 135 forwards information of the DRM system to the DRM system coordinator 145 in order to determine whether the DRM system type installed in the corresponding user terminal corresponds to a DRM system supported by the server 135.

The CDM 140 may build and manage a security environment with the DRM PSA 120 and execute the DRM server application in order to secure the compatibility with a specific DRM system.

The DRM system coordinator 145 is an entity for managing the DRM PSA 120 executed in the user terminal 100 and the DRM server application of the service providing apparatus 130. The DRM system coordinator 145 is connected to the DRM S/W database 150 which stores the DRM server application related to the DRM PSA S/W packages. The DRM system coordinator 145 determines the type and/or version of the DRM system installed in the user terminal 100 based on the DRM system information transferred from the server 135. When the information of the DRM system installed in the user terminal 100 does not correspond with the information of the DRM system supported in the server 135, or when the DRM system versions are different, the DRM system coordinator 145 searches for a corresponding DRM PSA in the DRM S/W database 150 such that the type of DRM PSA supported in the user terminal 100 can be installed in the user terminal 100.

The DRM system coordinator 145 provides the DRM PSA S/W package according to the request and makes the DRM PSA to maintain the newest version. Further, the DRM system coordinator 145 synchronizes a credential between the DRM PSA 120 and the CDM 140. The DRM system coordinator 145 serves to make the DRM server application used by the CDM 140 to maintain the newest version.

For convenience of description, FIG. 1 illustrates only the interface related to the download and installation of the DRM PSA, such as the interface between the client 105 and the server 135 and the interface between the DRM PSA 120 and the DRM system coordinator 145. Interfaces other than the above interfaces are generally unrelated to the present invention, so that their descriptions will be omitted.

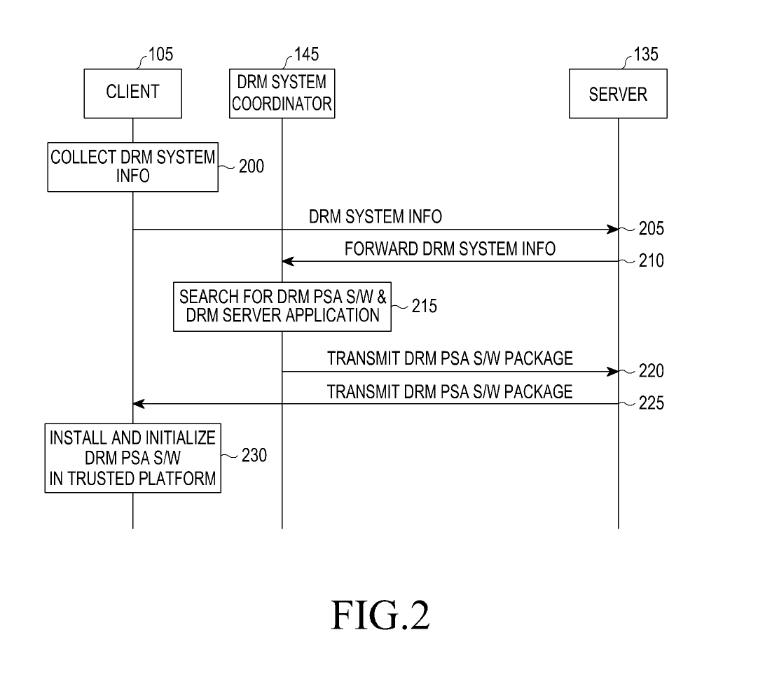

FIG. 2 illustrates a process of the download and installation of the DRM PSA according to the present invention.

Referring to FIG. 2, the client 105 collects information on the DRM system installed in the user terminal 100 in step 200. The information of the DRM system includes a type and a version of the DRM system. Then, the client 105 transfers the information of the DRM system collected to the server 135 in step 205. The server 135 forwards the information of the DRM system to the DRM system coordinator 145 in step 210.

The DRM system coordinator 145 searches for the corresponding DRM PSA S/W in the DRM S/W database 150 based on the information of the DRM system in step 215. Therefore, the searched DRM PSA S/W is the newest version, and the type of the DRM PSA supporting the format of the DRM system installed in the user terminal 100 is searched. The server 135 can also install the DRM server application in such a manner that the server 135 can convert a format of the information or message received from the DRM PSA 120 into a format recognizable in the server 135. To this end, in step 215, the DRM system coordinator 145 may simultaneously search for the DRM server application corresponding to the DRM PSA S/W, as well as the DRM PSA S/W. The searched DRM server application may be transferred to the CDM 140 and installed.

When the DRM system coordinator 145 transfers the searched DRM PSA S/W package to the server 135 in step 220, the server 135 transmits the DRM PSA S/W package to the client 105 in step 225. When the DRM system coordinator 145 determines that the DRM system coordinator 145 can support the DRM system installed in the user terminal 100, the DRM system coordinator 145 transfers the DRM PSA S/W package to the server 135. The server 135 may transfer the DRM PSA S/W package or only link information, through which the DRM PSA S/W package can be downloaded, to the client 105.

When the client 105 receives the DRM PSA S/W package, the client 105 installs and initializes the DRM PSA in the trusted platform in step 230. When the client 105 receives the link information, the client 105 may download the DRM PSA S/W package from an address corresponding to the link information and install the DRM PSA.

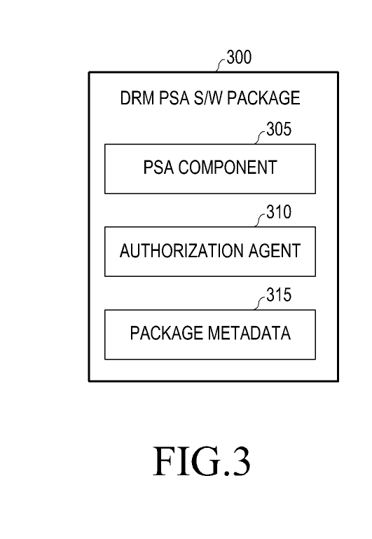

An example of the DRM PSA S/W package will be described with reference to FIG. 3. Referring to FIG. 3, the DRM PSA S/W package 300 includes a PSA component 305, an authorization agent 310, and package metadata 315.

The PSA component 305 is an S/W unit constituting the functions of the PSA.

The authorization agent 310 is a module for verifying the installation of the DRM S/W package, and transfers a result of the verification to the DRM system coordinator 145.

The package metadata 315 includes at least one of DRM SC Uniform Resource Locator (URL) which is URL information accessible to the DRM system coordinator 145, CDM URL which is URL information connectable to the CDM 140, a DRM PSA S/W package ID which is a unique ID of the DRM PSA 120, and credentials of the DRM PSA, which includes a certificate of the DRM PSA and/or a user ID/password.

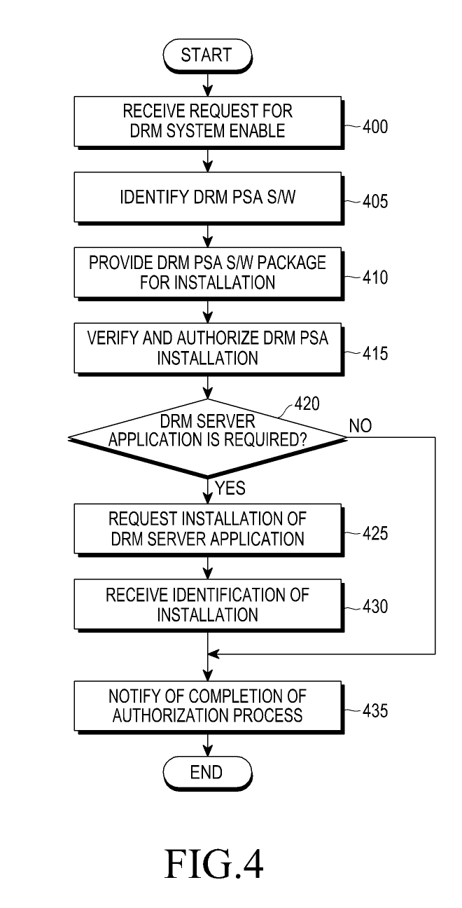

As described above, the DRM system coordinator 145 functions to manage the DRM PSA installed in the user terminal 100 and the DRM server application of the service providing apparatus 130. FIG. 4 illustrates the operation of the DRM system coordinator 145 according to the present invention.

When a new user terminal is registered in the service providing apparatus 130 for receiving the service, the DRM system coordinator 145 receives an enable request for a DRM system in step 400. That is, the request for activating the specific DRM system, such as the OMA DRM, installed in the user terminal 100 is transferred to the DRM system coordinator 145. A message of the request includes a DRM system type installed in the user terminal 100.

Then, the DRM system coordinator 145 identifies whether a DRM PSA S/W package related to the request exists in step 405. When the DRM PSA S/W package exists as a result of the identification, the DRM system coordinator 145 transfers the identified DRM PSA S/W package to the user terminal 100 in step 410. Accordingly, the installation of the DRM PSA is progressed.

The DRM system coordinator 145 verifies and authorizes the installation of the DRM PSA in step 415. The DRM system coordinator 145 determines whether the DRM server application is required in step 420. That is, the DRM system coordinator 145 determines whether the DRM server application interoperable with the DRM PSA S/W exists, but has yet to be installed.

If it is required to install the DRM server application, the DRM system coordinator 145 makes a request for the installation of the DRM server application interoperable with the DRM PSA S/W to the CDM 140 in step 425. The request may include the DRM server application package to be installed. When the DRM system coordinator 145 receives a result of the installation identification, which notifies of the completion of the installation of the DRM server application, from the CDM 140 in step 430, the DRM system coordinator 145 notifies the DRM PSA 120 of the user terminal 100 of the completion of an authorization process in step 435.

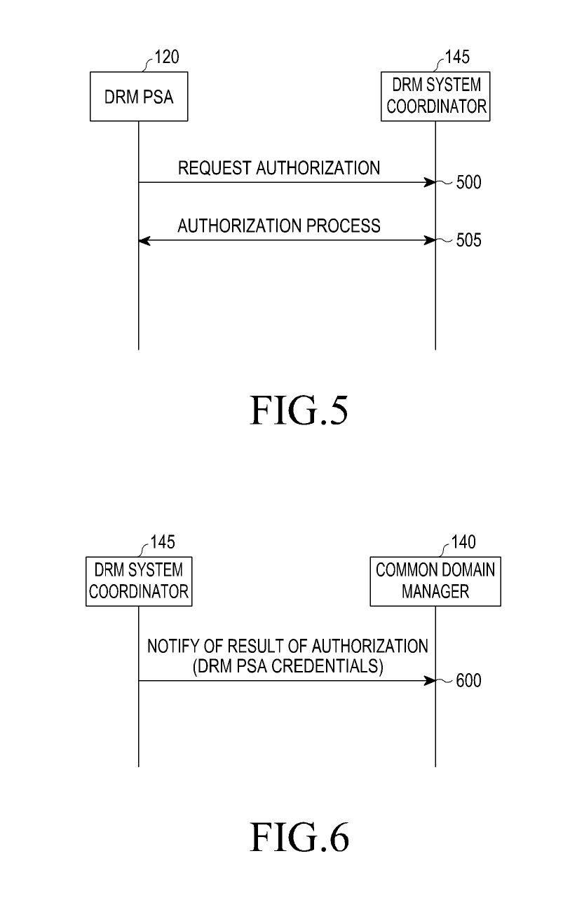

In the meantime, the process of the verification and authorization of the installation of the DRM PSA in step 415 of FIG. 4 will be specifically described with reference to FIG. 5.

Referring to FIG. 5, when the download and installation of the DRM PSA is completed, the DRM PSA 120 exists in the trusted platform as shown in FIG. 1. The DRM PSA 120 transmits an authorization request to the DRM system coordinator 145 in step 500. Therefore, an authorization process is performed between the DRM PSA 120 and the DRM system coordinator 145 in step 505.

The authorization process includes a process of making a request for an authorization agent 310, which is included in the DRM PSA S/W package shown in FIG. 3 and is to be executed in the user terminal 100, and transmitting a result of the execution of the authorization agent 310 to the DRM system coordinator 145. The authorization process may include a process of transmitting the authorization agent 310 to the DRM PSA 120. If the credential, such as the certificate and/or the user ID/password, is not designated in installing the DRM PSA S/W package, the authorization process may include a process of granting the credential to the DRM PSA 120.

The authorization process may include inter-authorizing the DRM PSA 120 and the DRM system coordinator 145 and generating a session key. As a result of the authorization process, a security environment between the DRM PSA 120 and the DRM system coordinator 145 may be built.

FIG. 6 illustrates a process of notifying of a result of an authorization in a DRM system coordinator according to the present invention. Referring to FIG. 6, the DRM system coordinator 145 notifies the CDM 140 of a result of the authorization in step 600.

The result of the authorization is of the DRM PSA, and may include information, such as a session key, for safe communication between the DRM PSA 120 and the CDM 140. The information for the safe information may include a chain of the certificate of the DRM PSA 120 and should essentially include identity information through which the DRM PSA 120 can be identified. For example, the identity information corresponds to a unique ID designated to the DRM PSA. The result of the authorization may include system information, such as version information, of the DRM PSA 120.

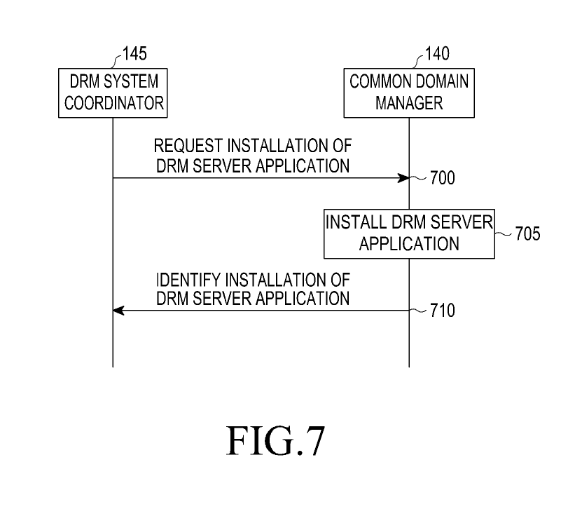

Steps 420 and 425 of FIG. 4 will be specifically described with reference to FIG. 7, which illustrates a case in which the DRM server application interoperable with the searched PSA S/W exists, but has yet to be installed. The DRM system coordinator 145 transfers a request for the installation of the searched DRM server application to the CDM 140 in step 700. Then, the CDM 140 installs the DRM server application in step 705, and transfers a result of the installation to the DRM system coordinator 145 in step 710.

When a new version of DRM PSA S/W package exists after the installation of the DRM PSA in the user terminal 100, it is required to upgrade the DRM PSA installed in the user terminal 100.

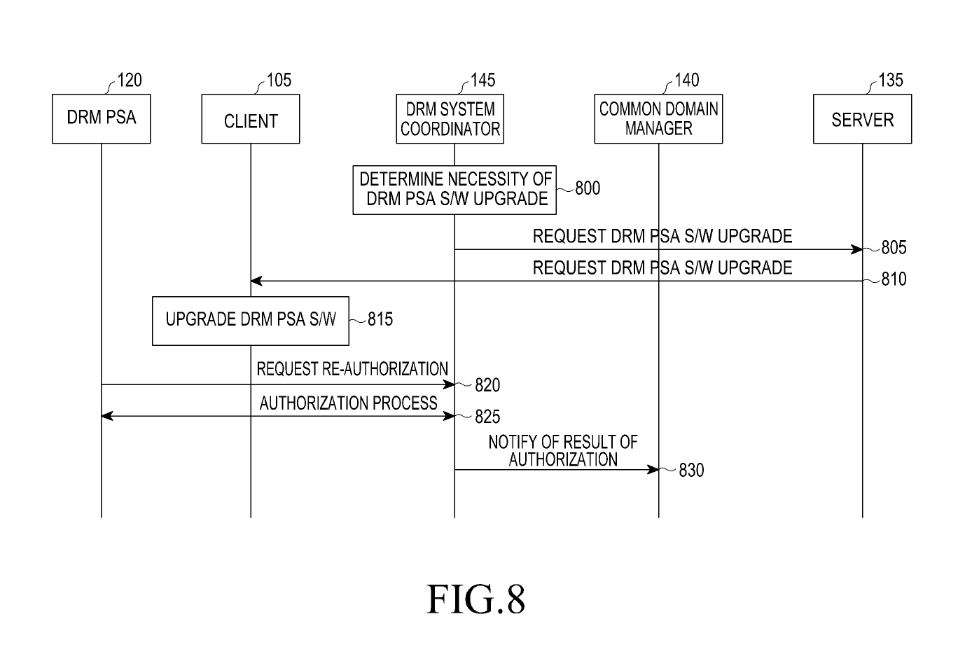

FIG. 8 illustrates a process of upgrading a DRM PSA according to the present invention.

Referring to FIG. 8, the DRM system coordinator 145 determines whether it is necessary to upgrade the DRM PSA S/W installed in the user terminal 100 in step 800. The necessity of the upgrade may be determined based on the DRM system information received from the user terminal 100 and stored in the DRM system coordinator 145 at the time of the installation of the DRM PSA. When the version within the information of the DRM system is lower in comparison with a version providable by the DRM system coordinator 145, the DRM system coordinator 145 transmits a message for requesting the DRM PSA S/W upgrade to the server 135. The message may include the new version of DRM PSA S/W package or a download link.

In response, the server 135 transmits the message for requesting the DRM PSA S/W upgrade to the client 105 in step 810. Then, the client 105 progresses the upgrade of the DRM PSA in the trusted platform 110 in step 815. When the upgrade is completed, the new version of the DRM PSA 120 transmits a request for authorization of the installation to the DRM system coordinator 145 in step 820. According to the transmission of the request for authorization, the DRM PSA 120 and the DRM system coordinator 145 perform the authorization process in step 825. When such an authorization process is completed, the DRM PSA 120 transmits a result of the authorization to the CDM 140. The result of the authorization includes a credential of the new DRM PSA as described with reference to FIG. 6.

Accordingly, the present invention enables the user terminal to use various DRM systems provided from the server regardless of the type of DRM system installed in the user terminal.

While the present invention has been shown and described with reference to certain embodiments and drawings thereof, it will be understood by those skilled in the art that various changes in form and details may be made therein without departing from the spirit and scope of the invention as defined by the appended claims.

What is claimed is:

1. A method of providing Digital Rights Management (DRM) service in a service providing apparatus for inter-compatibility between the service providing apparatus and a user terminal which employ different DRM systems, the method comprising:
acquiring information of a first DRM system installed in the user terminal;
determining whether the first DRM system installed in the user terminal is identical to a DRM system supported by the service providing apparatus based on the information of the first DRM system;
searching, when the service providing apparatus supports a second DRM system different from the first DRM system, for a software package including a common DRM interface, which is independent of a specific DRM system, and a module for providing a function of converting the common DRM interface into the first DRM system; and
providing the user terminal with the software package in such a manner that the module is installed in the user terminal.

2. The method as claimed in claim 1, wherein the information of the first DRM system comprises at least one of a type and a version of the DRM system installed in the user terminal.

3. The method as claimed in claim 1, wherein the module is a DRM proxy server agent for providing the DRM service by converting a format of the common DRM interface into a format of the first DRM system.

4. The method as claimed in claim 1, wherein the software package comprises at least one of the module, an authorization agent for verifying installation of the module and reporting of a result of the authorization, and package metadata.

5. The method as claimed in claim 4, wherein the package metadata comprises at least one of Uniform Resource Locator (URL) information accessible to the service providing apparatus, a unique Identifier (ID) of the module, and a credential of the module.

6. The method as claimed in claim 1, further comprising:
determining whether it is required to install a DRM server application related to the module; and
searching, when it is required to install the DRM server application, for and installing the DRM server application.

7. A service providing apparatus for providing Digital Rights Management (DRM) service for inter-compatibility between the service providing apparatus and a user terminal which employ different DRM systems, the apparatus comprising:
a server for receiving information of a first DRM system installed in the user terminal;
a database for storing at least one DRM server application for generating a license dependently on a DRM system supported in the service providing apparatus and at least one DRM proxy server agent software; and
a DRM system coordinator for determining whether the first DRM system installed in the user terminal is identical to a DRM system supported by the service providing apparatus based on the information of the first DRM system transferred from the server, when the service providing apparatus supports a second DRM system that is different from the first DRM system, searching for a DRM proxy server agent software package for supporting a common DRM interface in the database, and providing the user terminal with the DRM proxy server agent software package such that the DRM proxy server agent software is installed in the user terminal.

8. The service providing apparatus as claimed in claim 7, wherein the information of the first DRM system comprises at least one of a type and a version of the DRM system installed in the user terminal.

9. The service providing apparatus as claimed in claim 7, wherein the DRM proxy server agent software provides DRM service by converting a format of the common DRM interface into a format of the first DRM system.

10. The service providing apparatus as claimed in claim 7, wherein the DRM proxy server agent software comprises at least one of the DRM proxy server agent, an authorization agent for verifying installation of the DRM proxy server agent and reporting of a result of the authorization, and package metadata.

11. The service providing apparatus as claimed in claim 10, wherein the package metadata comprises at least one of Uniform Resource Locator (URL) information accessible to the service providing apparatus, a unique Identifier (ID) of the DRM proxy server agent, and a credential of the DRM proxy server agent.

12. The service providing apparatus as claimed in claim 7, wherein the DRM system coordinator determines whether it is required to install a DRM server application related to the DRM proxy server agent, and when it is required to install the DRM server application, the DRM system coordinator searches for the DRM server application.

13. The service providing apparatus as claimed in claim 12, further comprising a common domain manager for receiving a request for installing the searched DRM server application and installing the searched DRM server application.

14. The service providing apparatus as claimed in claim 13, wherein the DRM system coordinator synchronizes a credential between the DRM proxy server agent and the common domain manger and controls the DRM server application used by the common domain manager to maintain a newest version.

15. A method of receiving Digital Rights Management (DRM) service in a user terminal for inter-compatibility between a service providing apparatus and the user terminal which employ different DRM systems, the method comprising:
collecting information of a first DRM system installed in the user terminal;
transmitting collected information of the first DRM system to the service providing apparatus; and
receiving, from the service providing apparatus, when the service providing apparatus supports a second DRM system that is different from the first DRM system, a software package including a module, which provides the DRM service in accordance with a protocol of a common DRM interface.

16. The method as claimed in claim 15, wherein the information of the first DRM system comprises at least one of a type and a version of the DRM system installed in the user terminal.

17. The method as claimed in claim 15, wherein receiving the software package comprises receiving link information through which the software package can be downloaded.

18. The method as claimed in claim 15, wherein the module is a DRM proxy server agent for providing the DRM service by converting a format of the second DRM system into a format of the first DRM system.

19. The method as claimed in claim 15, wherein the software package comprises at least one of the module, an authorization agent for verifying installation of the module and reporting of a result of the authorization, and package metadata.

20. The method as claimed in claim 15, wherein the module corresponds to the common DRM interface.
